(19) United States
(12) Patent Application Publication
(10) Pub. No.: US 2007/0085797 A1
(43) Pub. Date: Apr. 19, 2007

(54) Thin film transistor array panel and liquid crystal display

(75) Inventor: Dong-Gyu Kim, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/546,156

(22) Filed: Oct. 10, 2006

(30) Foreign Application Priority Data
Oct. 17, 2005 (KR) 10-2005-0097704

(51) Int. Cl. G09G 3/36

(52) U.S. Cl. 345/93

(57) ABSTRACT

A thin film transistor array panel includes: a plurality of pixels including pixel electrodes arranged in a matrix and switching elements connected to the pixel electrodes; first and second gate lines that are connected to the switching elements extend in a row direction and correspond to one row of pixel electrodes; and first and second data lines that are connected to the switching elements extend in a column direction and correspond to three pixel columns. In the thin film transistor array panel, when the three pixel columns are referred to as first to third pixel columns, the pixel electrodes in the first and second pixel columns are connected to the first data line through the switching elements, and the pixel electrodes in the third pixel column are connected to the second data line through the switching elements.

### CROSS-REFERENCE TO RELATED APPLICATION

This application claims priority to and the benefit of Korean Patent Application No. 10-2005-0097704 filed in the Korean Intellectual Property Office on Oct. 17, 2005, the entire contents of which are incorporated herein by reference.

### FIELD OF THE INVENTION

The present invention relates to a liquid crystal display (LCD) having a thin film transistor array panel.

### DESCRIPTION OF THE RELATED ART

Liquid crystal displays include two display panels, one having pixel electrodes and the other having a common electrode with a liquid crystal layer having dielectric anisotropy between them. Pixel electrodes are arranged in a matrix, and are connected to switching elements such as thin film transistors (TFTs). A data voltage is sequentially applied to the rows of pixel electrodes. Common electrode is supplied with a common voltage. Pixel electrode, common electrode, and the anisotropic dielectric liquid crystal layer form a liquid crystal capacitor structure. Liquid crystal capacitor and switching element connected thereto constitute a pixel unit.

When a voltage is applied to the two electrodes of liquid crystal display, an electric field is generated in liquid crystal layer. The intensity of the electric field controls the transmittance of light passing through liquid crystal layer, thereby displaying a desired image. In order to prevent deterioration of display, the polarity of the data voltage with respect to common voltage is periodically inverted every frame, every column, or every pixel.

Liquid crystal display includes gate lines that transmit gate signals for controlling switching elements, data lines that transmit data voltages to be applied to field generating electrodes, a gate driver that generates gate signals, and a data driver that generates the data voltages. In general, gate driver and data driver are composed of a plurality of driver IC chips.

### SUMMARY OF THE INVENTION

In order to decrease the number of driver IC chips and thus to reduce manufacturing costs it is particularly important to reduce the number of data driver IC chips since they are more expensive than gate driving circuit chip.

In accordance with an embodiment of the present invention, two data lines are disposed for every three pixel columns thereby reducing the number of data driving chips for supplying signals to the data lines. While the number of gate lines is doubled, since gate driving chips are inexpensive, the increased number of gate driving chips does not have a significant effect on manufacturing cost. Further, since the gate driving circuit for supplying driving signals to the gate lines performs a very simple function, the gate driving circuit can be integrated into one substrate by using a thin film transistor forming process, thereby reducing the number of gate driving chips.

The thin film transistor array panel includes first and second gate lines that are connected to switching elements extending in a row direction correspond to a row of pixel electrodes and first and second data lines connected to switching elements extending in a column direction corresponding to three pixel columns. Referring to a group of three pixel columns, pixel electrodes in the first and second pixel columns are connected to the first data line through switching elements, and pixel electrodes in the third pixel column are connected to the second data line through switching elements.

The thin film transistor array panel includes a gate driving circuit that supplies a gate-on voltage or a gate-off voltage to the first and second gate lines. In addition, while applying gate-on voltage to the first gate line, gate driving circuit applies gate-on voltage to the second gate line.

The thin film transistor array panel further includes a data driving circuit that supplies image signals to the first and second data lines, and the data driving circuit may supply two-dot inversion driving signals.

The thin film transistor array panel may further include redundant data lines corresponding to the first to third pixel columns. A redundant data line may be connected to the first data line, and a predetermined voltage may be applied to the redundant data line.

The thin film transistor array panel may further include connecting portions each of which connects the first data line to the second data line, lead portions that connect the first and second data lines to the data driving circuit, and connecting members that connect the lead portions to the connecting portions. At least a part of the third data line may pass between the lead portion and the connecting portion to be connected to the data driving circuit.

When one pixel column group is composed of the first to third pixel columns that are sequentially arranged, the third data line of an even-numbered pixel column group may pass between the lead portion and the connecting portion to be connected to the data driving circuit, and the third data line of an odd-numbered pixel column group may not pass between the lead portion and the connecting portion.

Each of pixel electrodes may include two parallelogram-shaped electrode pieces inclined in different directions, and oblique sides of the two electrode pieces may intersect each other to form a pair of curved edges.

When the pair of sub-pixel electrodes serving as one pixel electrode are referred to as first and second sub-pixel electrodes, the first sub-pixel electrode may overlap the first storage electrode line, and the second sub-pixel electrode may overlap the second storage electrode line. Different voltages may be applied to the first storage electrode line and the second storage electrode line.

The thin film transistor array panel may further include third storage electrode lines that overlap the second sub-pixel electrodes. In addition, different voltages may be applied to the first storage electrode line and the second storage electrode line, and the same voltage may be applied to the second storage electrode line and the third storage electrode line.

Each of switching elements may include a gate electrode that is connected to the first gate line or the second gate line, a source electrode that is connected to any one of the first to third data lines, and a drain electrode that is opposite to the source electrode above gate electrode and has an expanded portion. The expanded portions of drain electrodes in the first and third pixel columns may overlap the first storage electrode lines, and the expanded portions of drain electrodes in the second pixel column may overlap the second storage electrode lines. Each of the sub-pixel electrodes may include two parallelogram-shaped electrode pieces inclined in different directions, and oblique sides of the two electrode pieces may intersect each other to form a pair of curved edges.

### BRIEF DESCRIPTION OF THE DRAWING

The foregoing objects and features of the present invention may become more apparent from the ensuing description when read together with the drawing, in which:

FIG. 1 is a block diagram illustrating a liquid crystal display according to an exemplary embodiment of the present invention;

FIG. 2 is an equivalent circuit diagram of one pixel of the liquid crystal display according to the exemplary embodiment of the present invention;

FIG. 3 is a circuit diagram illustrating a thin film transistor array panel according to an exemplary embodiment of the present invention;

FIG. 4 is a layout view illustrating the thin film transistor array panel according to the exemplary embodiment of the present invention;

FIG. 5 is a cross-sectional view of the thin film transistor array panel that is taken along the line V-V′ of FIG. 4, and FIG. 5 is a cross-sectional view of the thin film transistor array panel that is taken along the line VI-VI′ of FIG. 4;

FIGS. 7A and 7B are timing charts illustrating a driving voltage for a liquid crystal display according to an exemplary embodiment of the present invention;

FIGS. 8 to 12 and FIGS. 14 and 15 are layout views illustrating a thin film transistor array panel according to another exemplary embodiment of the present invention; and

FIG. 13 is a cross-sectional view taken along the line XIII-XIII of FIG. 12.

### DETAILED DESCRIPTION OF THE EMBODIMENTS

The present invention will be described more fully hereinafter with reference to the accompanying drawings, in which preferred embodiments of the invention are shown. In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

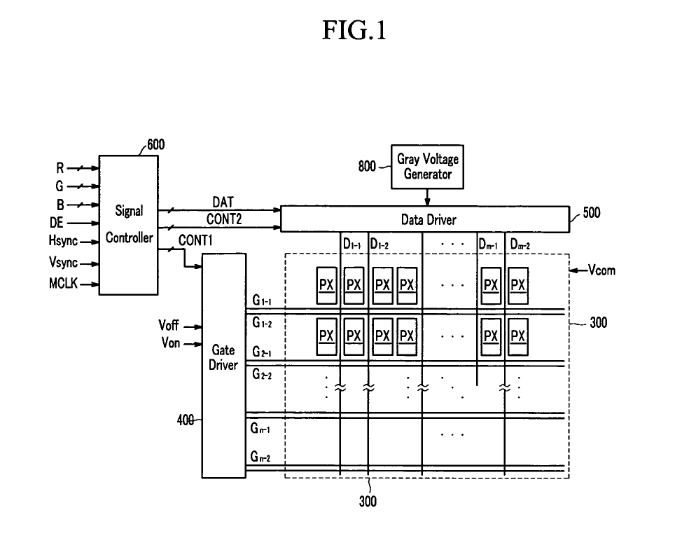

As shown in FIG. 1, liquid crystal display according to the exemplary embodiment of the present invention includes a liquid crystal panel assembly 300, a gate driver 400 and a data driver 500 connected to liquid crystal panel assembly 300, a gray voltage generator 800 connected to data driver 500, and a signal controller 600 for controlling the above-mentioned components. In the equivalent circuit diagram, liquid crystal panel assembly 300 is connected to a plurality of display signal lines G₁₋₁ to Gₙ₋₂ and D₁₋₁ to Dₘ₋₂ and includes a plurality of pixels arranged substantially in a matrix.

Display signal lines G₁₋₁ to Gₙ₋₂ and D₁₋₁ to Dₘ₋₂ include a plurality of gate lines G₁₋₁ to Gₙ₋₂ for transmitting gate signals (referred to as “scanning signals”) and a plurality of data lines D₁₋₁ to Dₘ₋₂ for transmitting data signals. Gate lines G₁₋₁ to Gₙ₋₂ extend substantially in a row direction so as to be parallel to each other, and data lines D₁₋₁, to Dₘ₋₂ extend substantially in a column direction so as to be parallel to each other.

Each pixel includes a switching element Q connected to one of display signal lines G₁₋₁ to Gₙ₋₂ and D₁₋₁ to Dₘ₋₂, a liquid crystal capacitor C_{LC} connected to switching element Q, and a storage capacitor C_{ST}. Storage capacitor C_{ST} may be omitted if necessary.

Switching element Q is a three-terminal element, such as a thin film transistor, and is provided on lower panel 100. A control terminal of switching element Q is connected to gate line G₁₋₁ to Gₙ₋₂, an input terminal thereof is connected to the data line D₁₋₁ to Dₘ₋₂, and an output terminal thereof is connected to liquid crystal capacitor C_{LC} and storage capacitor C_{ST}.

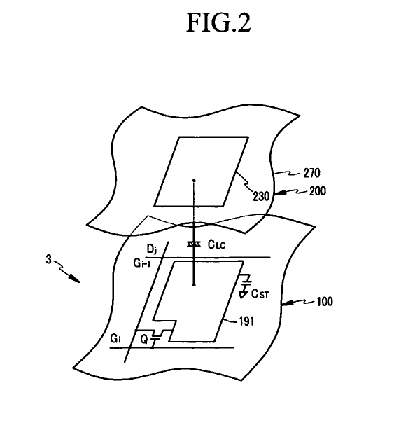

Liquid crystal capacitor C_{LC} has as two terminals, a pixel electrode 191 of lower panel 100 and a common electrode 270 of upper panel 200 with a liquid crystal layer 3 between the two electrodes as a dielectric material. Pixel electrode 191 is connected to switching element Q, and common electrode 270 is formed on the entire surface of the upper panel 200 and is supplied with a common voltage Vcom. Unlike the structure shown in FIG. 2, common electrode 270 may be provided on lower panel 100 in which case at least one of the two electrodes 191 and 270 may be formed in a linear or bar shape.

Storage capacitor C_{ST}, serving as an auxiliary member of liquid crystal capacitor C_{LC}, is composed of a signal line (not shown) provided on the lower panel 100, pixel electrode 191, and an insulator interposed therebetween. A predetermined voltage, such as common voltage Vcom, is applied to the signal line. Alternatively, storage capacitor C_{ST} may be a laminated structure of pixel electrode 191, the insulator, and a previous gate line formed on the insulator.

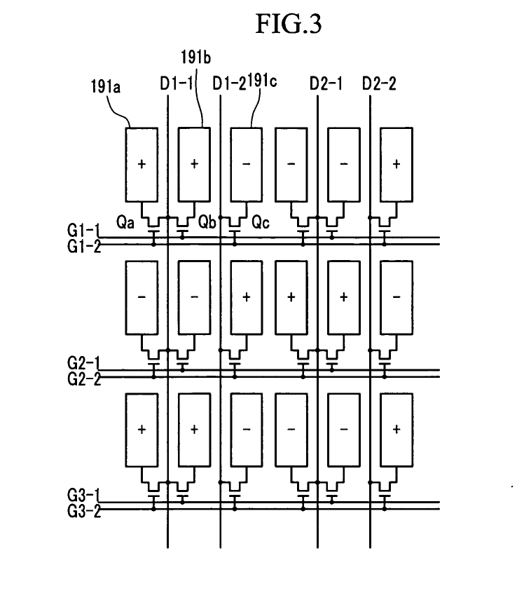

As shown in FIG. 3, each pair of gate lines G₁₋ₙ and G₁₋₍ₙ₊₁₎ (n is a natural number) are sequentially disposed below the corresponding row of pixel electrodes 191. Each of data lines D₁₋₁, D₁₋₂, D₂₋₁, D₂₋₂ and so on is disposed between two adjacent columns of pixels. Assuming that three pixel columns belong to one pixel column group, a pair of data lines D₁₋₁ and D₁₋₂, D₂₋₁ and D₂₋₂, or the like are included in one pixel column group so that no data line is provided between one pixel column group and another pixel column group. Connection among pixel electrodes 191, gate lines G₁₋₁ to Gₙ₋₂, and data lines D₁₋₁ to Dₘ₋₂ will be described in detail below.

A plurality of pairs of gate lines G₁₋₁ to Gₙ₋₂ are disposed below pixel electrodes 191a, 191b, and 191c and are connected to pixel electrodes 191a, 191b, and 191c through switching elements Qa, Qb, and Qc arranged below pixel electrodes 191a, 191b, and 191c. In this structure, when an upper gate line of a pair of gate lines Gₙ₋₁ and Gₙ₋₂ is referred to as a first gate line Gₙ₋₁ and a lower gate line thereof is referred to as a second gate line Gₙ₋₂, the first gate line Gₙ₋₁ is connected to pixel electrode 191b in the first pixel column of the pixel column groups, and the second gate line Gₙ₋₂ is connected to the first and third pixel electrodes 191a and 191c in the first and third pixel columns of the pixel column groups.

The plurality of pairs of data lines D₁₋₁ to Dₘ₋₂ disposed among pixel electrodes 191a, 191b, and 191c are connected to the corresponding pixel electrodes 191a, 191b, and 191c through switching elements Qa, Qb, and Qc arranged below pixel electrodes 191a, 191b, and 191c. In this structure, when a left data line of two data lines in one pixel column group is referred to as a first data line Dₘ₋₁ and a right data line thereof is referred to as a second data line Dₘ₋₂, the first data line Dₘ₋₁ is connected to pixel electrodes 191a and 191b in the first and second pixel columns that are disposed on both sides of the first data line Dₘ₋₁, and the second data line Dₘ₋₂ is connected to pixel electrode 191c in the third pixel column that is disposed on the right side of the second data line Dₘ₋₂.

That is, switching element Qa in the first pixel column is connected to the second gate line Gₙ₋₂, the first data line Dₘ₋₁, and pixel electrode 191a in the first pixel column, and switching element Qb in the second pixel column is connected to the first gate line Gₙ₋₁, the first data line Dₘ₋₁, and pixel electrode 191b in the second pixel column. In addition, switching element Qc in the third pixel column is connected to the second gate line Gₙ₋₂, the second data line Dₘ₋₂, and pixel electrode 191c in the third pixel column.

In order to perform color display, each pixel specifically displays one of the primary colors (spatial division), or the pixels alternately display the primary colors with time (temporal division), which causes the primary colors to be spatially and temporally synthesized, thereby displaying a desired color. As an example of the spatial division, FIG. 2 shows that each pixel has a color filter 230 for displaying one of red, green, and blue in a region corresponding to pixel electrode 191. Unlikely the structure shown in FIG. 2, the color filter 230 may be provided above or below pixel electrode 191 of the lower panel 100.

In FIG. 3, it is preferable that the first to third pixel columns of one pixel column group are red, green, and blue pixel columns, respectively. Alternatively, the first to third pixel columns may be formed of different combinations of red, green, and blue pixel columns.

A polarizer (not shown) for polarizing light is mounted to an outer surface of at least one of the two display panels 100 and 200 of liquid crystal panel assembly 300.

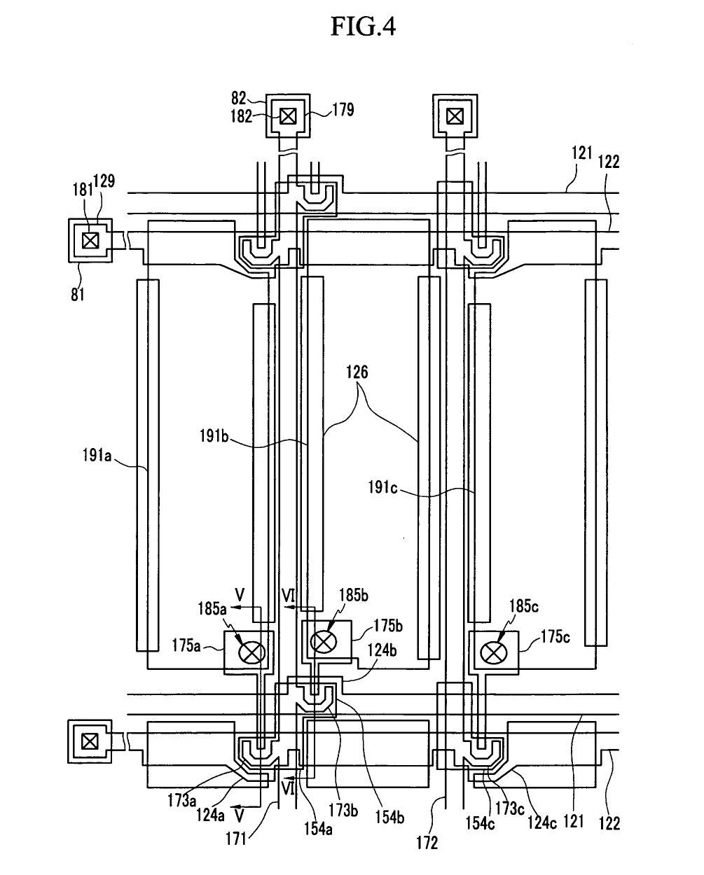

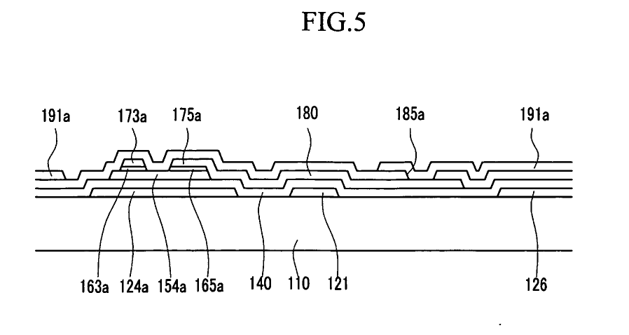

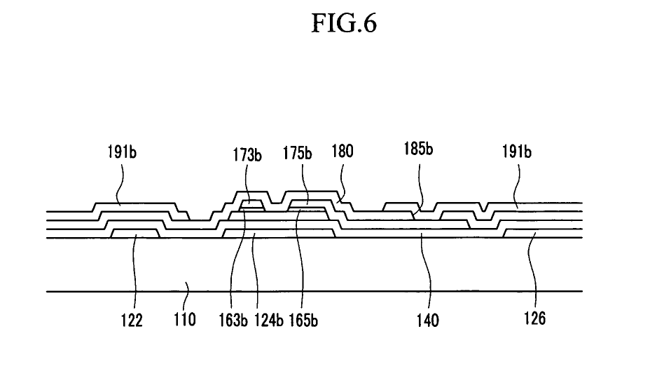

Next, the structure of the thin film transistor array panel 100 of liquid crystal panel assembly 300 will be described in detail with reference to FIGS. 4 to 6. FIG. 4 is a layout view illustrating the thin film transistor array panel according to an exemplary embodiment of the present invention, FIG. 5 is a cross-sectional view of the thin film transistor array panel taken along the line V-V′ of FIG. 4, and FIG. 6 is a cross-sectional view of the thin film transistor array panel taken along the line VI-VI′ of FIG. 4.

As described above, liquid crystal display according to the exemplary embodiment of the present invention includes thin film transistor array panel 100, a common electrode panel 200 opposite the thin film transistor array panel 100, and a liquid crystal layer 3 interposed between the thin film transistor array panel 100 and the common electrode panel 200.

Next, the thin film transistor array panel 100 will be described in detail. A plurality of pairs of gate lines 121 and 122 and a light leakage prevention member 126 are formed on an insulation substrate 110 made of, for example, transparent glass.

The pairs of gate lines 121 and 122 extend in the horizontal direction. A portion of each gate line 121 protrudes upward to form a gate electrode 124b, and portions of each gate line 122 protrude downward to form gate electrodes 124a and 124c. Gate line 121 is connected to a gate driving circuit (not shown) integrated into the substrate 110, and one end 129 of gate line 122 has a large width for connection to other layers or an external device.

The light leakage prevention member 126 is longitudinally formed in the vertical direction between two pairs of gate lines 121 and 122 adjacent to each other, and two light leakage prevention members 126 are disposed on both sides of a pixel area of each pixel.

Gate lines 121 and 122 and the light leakage prevention member 126 may be formed of, for example, an aluminum-based metallic material such as aluminum (Al) or an aluminum alloy, a silver-based metallic material such as silver (Ag) or a silver alloy, a copper-based metallic material such as copper (Cu) or a copper alloy, a molybdenum-based metallic material such as molybdenum (Mo) or a molybdenum alloy, chromium (Cr), tantalum (Ta), or titanium (Ti). Alternatively, gate lines 121 and 122 and the light leakage prevention member 126 may include two films having different physical properties, that is, a lower layer (not shown) and an upper layer (not shown). The upper layer may be formed of a metallic material having low resistivity, for example an aluminum-based metallic material such as aluminum (Al) or an aluminum alloy, a silver-based metallic material such as silver (Ag) or a silver alloy, or a copper-based metallic material such as copper (Cu) or a copper alloy, in order to reduce a signal delay or voltage drop in gate lines 121 and 122 and the light leakage prevention member 126. In contrast, the lower layer may be formed of a material different from the material forming the upper layer, that is, a material having a good contact characteristic with, particularly, ITO (indium tin oxide) and IZO (indium zinc oxide), such as chromium, molybdenum (Mo), a molybdenum alloy, tantalum (Ta), or titanium (Ti). Chromium/aluminum-neodymium (Nd) alloy may be given as a representative example of a combination of the lower layer and the upper layer.

The side surfaces of gate lines 121 and 122 the light leakage prevention member 126 are inclined with respect to the surface of the substrate 110, preferably at an angle of about 30° to 80°.

A gate insulating layer 140 formed of, for example, silicon nitride (SiNₓ) is formed on gate lines 121 and 122 and the light leakage prevent member 126.

A plurality of semiconductor islands 154a, 154b, and 154c formed of hydrogenated amorphous silicon (abbreviated as a-Si) or polysilicon, for example, are formed on gate insulating layer 140. Semiconductors 154a, 154b, and 154c are positioned above gate electrodes 124a, 124b, and 124c, respectively, and a connecting part between the two semiconductors 154a and 154b covers gate lines 121 and 122. Semiconductor 154c extends so as to cover the two gate lines 121 and 122.

A plurality of ohmic contact islands 163a, 163b, 165a, and 165b formed of n+ hydrogenated amorphous silicon containing silicide or an n-type impurity doped at a high concentration, for example, are formed on semiconductors 154a, 154b, and 154c. A pair of ohmic contacts 163a and 165a and a pair of ohmic contacts 163b and 165b are disposed on semiconductor islands 154a and 154b, respectively. A pair of island-shaped ohmic contacts (not shown) are formed on semiconductor 154c.

The side surfaces of semiconductors 154a, 154b, and 154c and ohmic contacts 163a, 163b, 165a, and 165b are also inclined with respect to the surface of the substrate 110, preferably at an angle of about 30° to 80°.

A plurality of pairs of data lines 171 and 172 and a plurality of drain electrodes 175a, 175b, and 175c are respectively formed on ohmic contacts 163a, 163b, 165a, and 165b and gate insulating layer 140.

Data lines 171 and 172 extend in the vertical direction to intersect gate lines 121 and 122 and transmit a data voltage. An end 179 of each of data lines 171 and 172 has a large width for connection to other layers or an external device. A plurality of hook-shaped branches extending from data lines 171 and 172 to drain electrodes 175a, 175b, and 175c in the right or left direction form source electrodes 173a, 173b, and 173c, respectively. Drain electrodes 175a, 175b, and 175c each have one end having a linear shape and the other end having a large width for connection to other layers. The data line 171 has source electrodes 173a and 173b extending in the right and left directions, and the source electrodes 173a and 173b are disposed on semiconductors 154a and 154b, respectively. The data line 172 has a source electrode 173c extending in the right direction, and the source electrode 173c is disposed on semiconductor 154c.

Gate electrodes 124a, 124b, and 124c, the source electrodes 173a, 173b, and 173c, and drain electrodes 175a, 175b, and 175c form a thin film transistor (TFT) together with semiconductor islands 154a, 154b, and 154c. Channels of the thin film transistor are formed in semiconductor islands 154a, 154b, and 154c between the source electrodes 173a, 173b, and 173c and drain electrodes 175a, 175b, and 175c.

Data lines 171 and 172 and drain electrodes 175a, 175b, and 175c may be formed of a refractory metallic material, such as a molybdenum-based metallic material, chromium, tantalum, or titanium, or they may have a multilayered structure of an upper layer having low resistance and a lower layer having a good contact characteristic.

The side surfaces of data lines 171 and 172 and drain electrodes 175a, 175b, and 175c are also inclined at an angle of about 30° to 80°, similar to gate lines 121 and 122.

Ohmic contacts 163a, 163b, 165a, and 165b are provided only between semiconductor 154a, 154b, and 154c arranged below ohmic contacts, and the data line 171 and drain electrodes 175a, 175b, and 175c arranged above ohmic contacts, and function to reduce contact resistance.

As described above, semiconductor islands 154a, 154b, and 154c cover boundaries between gate lines 121 and 122 and data lines 171 and 172 or drain electrode 175a, 175b, and 175c to prevent data lines 171 and 172 from being broken.

A passivation layer 180 is formed on data lines 171 and 172, drain electrodes 175a, 175b, and 173c, and exposed portions of semiconductors 154a, 154b, and 154c. Passivation layer 180 is formed of an organic material having a good planarizing characteristic and photosensitivity, an insulating material having a low dielectric constant of smaller than 4.0 such as a-Si:C:O or a-Si:O:F that is formed by plasma enhanced chemical vapor deposition (PECVD), or an inorganic material such as silicon nitride, for example. Alternatively, passivation layer 180 may be formed in a two-layer structure of an organic material film and a silicon nitride film.

A plurality of contact holes 185a, 185b, 185c, and 182 are formed in passivation layer 180 so that the ends 179 of data lines 171 and 172 and drain electrodes 175a, 175b, and 175c are exposed, and a plurality of contact holes 181 are also formed in passivation layer 180 to expose an end 129 of gate line 122 and gate insulating layer 140.

A plurality of pixel electrodes 191a, 191b, and 191c formed of ITO or IZO, for example, and a plurality of contact assistants 81 and 82 are formed on passivation layer 180.

Pixel electrodes 191a, 191b, and 191c are physically and electrically connected to drain electrodes 175a, 175b, and 175c through the contact holes 185a, 185b, and 185c to be supplied with a data voltage from drain electrodes 175a, 175b, and 175c, respectively. Pixel electrodes 191a, 191b, and 191c supplied with the data voltage and common electrode 270 of display panel 200 supplied with a common voltage Vcom generate an electric field, which causes liquid crystal molecules of liquid crystal layer 3 between pixel electrodes 191a, 191b, and 191c and common electrode 270 to be rearranged.

Pixel electrode 191a, 191b, or 191c and common electrode 270 form liquid crystal capacitor C_{LC}, and liquid crystal capacitor C_{LC} maintains a voltage applied thereto after the thin film transistor is turned off. In order to enhance the voltage maintaining performance, storage capacitor C_{ST} is connected in parallel to liquid crystal capacitor C_{LC}. Storage capacitor C_{ST} is formed by overlapping pixel electrode 190 and the previous gate line 122 adjacent to pixel electrode 190.

Pixel electrodes 191a, 191b, and 191c cover expanded end portions of drain electrodes 175a, 175b, and 175c, respectively, and the light leakage prevention member 126 is arranged so as to overlap the right and left sides of each of pixel electrodes 191a, 191b, and 191c. The light leakage prevention member 126 prevents light from leaking from data lines 171 and 172 due to the voltage of data lines 171 and 172.

Contact assistants 81 and 82 are connected to the end 129 of gate line 122 and the ends 179 of data lines 171 and 172 through the contact holes 181 and 182, respectively. Contact assistants 81 and 82 function to ensure connection between an external device and the ends 129 and 179 of gate line 122 and data lines 171 and 172 and to protect the connected portions. When a gate driver (not shown) for supplying scanning signals to gate line 122 is integrated into display panel, the contact assistant 81 can serve as a member for connecting gate driver to the end 129 of gate line 122. The contact assistant 81 may be omitted, if necessary.

According to another exemplary embodiment of the present invention, pixel electrodes 191a, 191b, and 191c are formed of a transparent conductive polymer. In a reflective liquid crystal display, pixel electrode may be formed of an opaque reflective metal. In this case, contact assistants 81 and 82 may be formed of a material different from that forming pixel electrodes 191a, 191b, and 191c, particularly, ITO or IZO.

An alignment layer (not shown) is formed on pixel electrodes 191a, 191b, and 191c to align liquid crystal layer 3.

In the thin film transistor array panel having the above-mentioned structure, two data lines 171 and 172 are formed for every three pixel columns. Therefore, it is possible to reduce the number of data lines to two thirds of that in the conventional thin film transistor array panel. Accordingly, the number of data driving chips for supplying signals to data lines is also reduced, resulting in lower manufacturing cost. In contrast, the number of gate lines doubles, which causes the number of gate driving chips to double. However, since gate driving chips are inexpensive, this does not have a significant effect on the manufacturing cost. Further, since a gate driving circuit for supplying driving signals to gate lines 121 performs a very simple function, the gate driving circuit can be integrated into substrate 110 by using a thin film transistor forming process, which makes it possible to prevent an increase in the number of gate driving chips.

In the thin film transistor array panel having the above-mentioned structure, when three pixel columns belonging to one pixel column group are arranged so as to correspond to red, green, and blue pixel columns, red, green, and blue pixels have the same shape in the entire display area. Therefore, it is possible to ensure the uniformity of display and thus to improve display quality. Next, the driving of a liquid crystal display having the thin film transistor array panel applied thereto will be described below with reference to FIGS. 1 to 3.

Referring to FIG. 1, gray voltage generator 800 generates two pairs of gray voltages related to the transmittance of the pixels. One of the pairs of gray voltages has a positive value with respect to common voltage Vcom, and the other pair of gray voltages has a negative value with respect to common voltage Vcom.

Gate driver 400 is connected to gate lines G₁₋₁ to Gₙ₋₂ of liquid crystal panel assembly 300, and applies gate signals, each composed of a combination of a gate-on voltage Vₒₙ and a gate-off voltage V_{off} supplied from the outside, to gate lines G₁₋₁ to Gₙ₋₂. Gate driver 400 is composed of a plurality of ICs.

Data driver 500 is connected to data lines D₁₋₁ to Dₘ₋₂ of liquid crystal panel assembly 300, selects gray voltage generated by gray voltage generator 800, and applies the selected gray voltage to the pixels as a data signal.

Each of the gate driving ICs or the data driving ICs may be mounted on an FPC substrate in the form of a chip, and the FPC substrate may be mounted on liquid crystal panel assembly 300. Alternatively, they may be directly mounted on a glass substrate without using the FPC substrate (chip on glass (COG) mounting method), or circuits performing the same functions as these ICs may be directly formed in liquid crystal panel assembly 300 together with the thin film transistors of the pixels. Signal controller 600 controls gate driver 400 and data driver 500.

Next, the operation of the liquid crystal display will be described in detail. Signal controller 600 receives from an external graphics controller (not shown) input image signals R, G, and B and input control signals for controlling display of the input image signals R, G, and B. For example, any of the following signals may be used as the input control signal: a vertical synchronization signal Vsync, a horizontal synchronization signal Hsync, a main clock signal MCLK, and a data enable signal DE. The signal controller 600 processes the input image signals R, G, and B so as to be suitable for the operational condition of liquid crystal panel assembly 300 on the basis of the input control signal to generate a gate control signal CONT1 and a data control signal CONT2, for example. Then, the signal controller 600 transmits gate control signal CONT1 to gate driver 400 and transmits the data control signal CONT2 and the processed image signal DAT to data driver 500. The processing of the image signals R, G, and B includes an operation of rearranging the image signals R, G, and B according to the arrangement of the pixels of liquid crystal panel assembly 300.

Gate control signal CONT1 includes a scanning start signal STV indicating the start of the output of a gate-on voltage Vₒₙ and at least one clock signal for controlling the output time of gate-on voltage Vₒₙ and an output voltage.

Data control signal CONT2 includes a horizontal synchronization start signal STH indicating that the transmission of the image signal DAT starts, a load signal TP for allowing a data voltage to be applied to data lines D₁₋₁ to Dₘ₋₂, an inversion signal RVS for inverting the polarity of a data voltage with respect to common voltage Vcom (hereinafter, “the polarity of a data voltage with respect to common voltage” is simply referred to as “the polarity of a data voltage”), and a data clock signal HCLK.

Data driver 500 sequentially receives groups of image data DAT for a row of pixels in response to the data control signal CONT2 transmitted from the signal controller 600, selects a gray voltage corresponding to each image data DAT among gray voltages generated by gray voltage generator 800, converts the image data DAT into a corresponding data voltage, and applies the data voltage to data lines D₁₋₁ to Dₘ₋₂.

Gate driver 400 sequentially applies gate-on voltage Vₒₙ to gate lines G₁₋₁ to Gₙ₋₂ on the basis of gate control signal CONT1 from the signal controller 600 to turn on switching elements Q connected to gate lines G₁₋₁ to Gₙ₋₂. Then, the data voltage applied to data lines D₁₋₁ to Dₘ₋₂ is applied to the corresponding pixels through switching elements Q in the on state.

The difference between the data voltage applied to the pixel and common voltage Vcom is a charging voltage of liquid crystal capacitor C_{LC}, that is, a pixel voltage. The alignment directions of liquid crystal molecules depend on the level of the pixel voltage, which causes the polarization of light passing through liquid crystal layer 3 to vary. The variation in polarization causes a variation in the transmittance of light by polarizers (not shown) mounted on display panels 100 and 200.

In this structure, image data for the first and second pixel columns of a pixel column group is transmitted through the first data line Dₘ₋₁, and image data for the third pixel column of the pixel column group is transmitted through the second data line Dₘ₋₂. The image data transmitted through the first data line Dₘ₋₁ is selected by the scanning signals transmitted through the first and second gate lines Gₙ₋₁ and Gₙ₋₂, and is then supplied to the pixels in the first column or the second column. The image data transmitted through the second data line Dₘ₋₂ is selected by the scanning signal transmitted through the second gate line Gₙ₋₂ and is then supplied to the pixels of the third column.

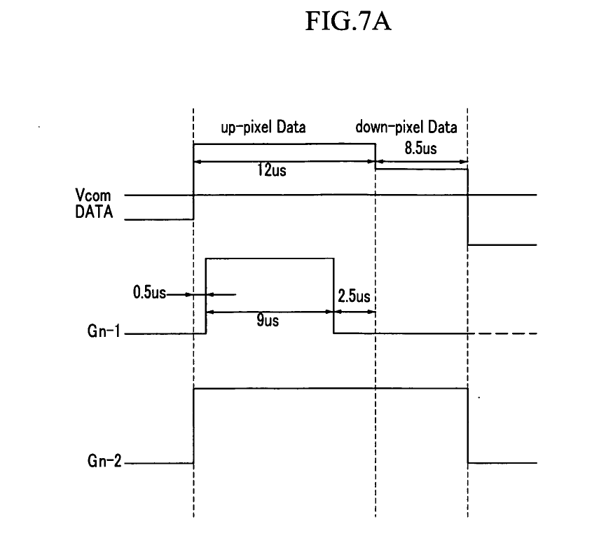

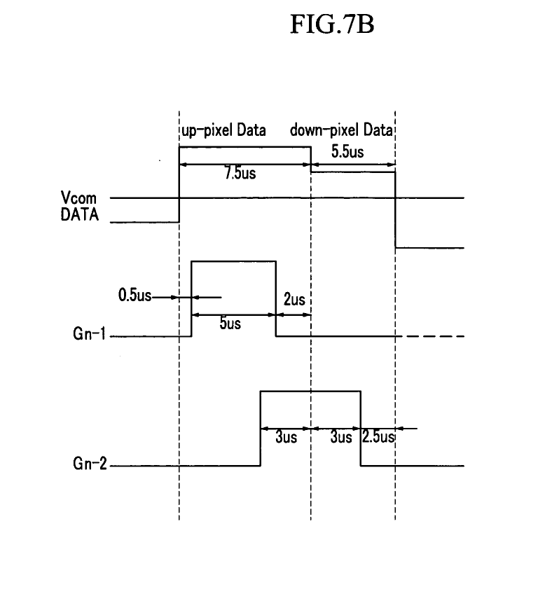

The number of gate lines Gₙ₋₁ and Gₙ₋₂ is twice that in the conventional thin film transistor array panel having the same resolution as the thin film transistor array panel according to the exemplary embodiment of the present invention. Therefore, the on time given to each gate line is shortened in proportion to an increase in the number of gate lines. As gate-on time becomes shorter, the time required to charge pixel electrode is reduced. However, when gate-on time is excessively short, pixel electrode may not reach a target voltage. In order to solve this problem, overlap driving may be performed, as shown in FIGS. 7A and 7B.

FIGS. 7A and 7B are timing charts illustrating driving voltages of a liquid crystal display according to an exemplary embodiment of the present invention. In FIG. 7A, a gate-on voltage is simultaneously applied to the first gate line Gₙ₋₁ and the second gate line Gₙ₋₂ to pre-charge the first and third pixel columns while the second pixel column is being charged. Even after gate-on voltage applied to the first gate line Gₙ₋₁ is changed to a gate-off voltage, gate-on voltage is applied to the second gate line Gₙ₋₂ for a predetermined period such that the first and third pixel columns are charged. That is, gate-on voltage is continuously applied to the second gate line Gₙ₋₂ for gate-on time of the first gate line Gₙ₋₁ and for a predetermined period after gate-on time.

In FIG. 7B, gate-on voltage is applied to the first gate line Gₙ₋₁, and gate-on voltage is also applied to the second gate line Gₙ₋₂ before gate-on voltage applied to the first gate line Gₙ₋₁ is changed to a gate-off voltage to pre-charge the first and third pixel columns while the second pixel column is being charged. Even after gate-on voltage applied to the first gate line Gₙ₋₁ is changed to gate-off voltage, gate-on voltage is applied to the second gate line Gₙ₋₂ for a predetermined period such that the first and third pixel columns are charged. That is, gate-on voltage is continuously applied to the second gate line Gₙ₋₂ for gate-on time of the first gate line Gₙ₋₁ and for a predetermined period after gate-on time.

This overlap driving is useful for two-dot inversion driving, that is, inversion driving in the order of +, +, −, −, +, +, −, −. In the two-dot inversion driving, the pre-charging and the main charging can be performed on the first and third pixel columns with a voltage having the same polarity.

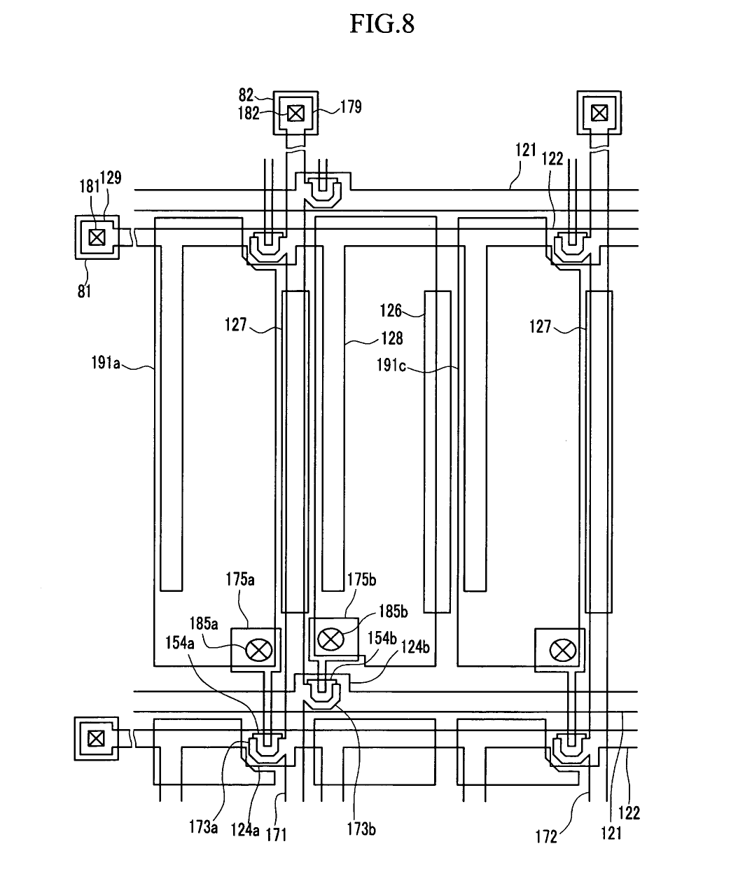

Next, a thin film transistor array panel according to another exemplary embodiment of the present invention will be described in detail with reference to FIGS. 8 to 14. FIG. 8 is a layout view illustrating the thin film transistor array panel according to another exemplary embodiment of the present invention.

The arrangement of pixels shown in FIG. 8 is similar to the arrangement of pixels shown in FIG. 4. That is, a pair of gate lines 121 and 122 are sequentially arranged below of a row of pixel electrodes 191a, 191b, and 191c, and two data lines 171 and 172 are disposed for every three pixel columns.

The present exemplary embodiment differs from the exemplary embodiment shown in FIG. 4 in that the data line 172 for supplying image signals to the third pixel column is disposed on the right side of the third pixel column. The present exemplary embodiment is characterized in that a light leakage prevention member 128 on the left side in a pixel area is connected to gate line 122. The connection between the light leakage prevention member 128 and gate line 122 makes it possible to increase the capacitance of a storage capacitor when the previous gate line is used to form storage capacitor. Therefore, in this exemplary embodiment, the width of gate line 122 can be narrowed, as compared with the exemplary embodiment shown in FIG. 4, which enables an improvement of an aperture ratio. A semiconductor has substantially the same plane pattern as data lines 171 and 172 and drain electrodes 175a, 175b, and 175c, and has exposed portions 154a, 154b, and 154c between the source electrodes 173a, 173b, and 173c and drain electrodes 175a, 175b, and 175c. A light blocking member 127 is formed below data lines 171 and 172. The light blocking member 127 prevents a leakage current due to photo-electrons that are generated when light emitted from a backlight is incident on semiconductor formed below data lines 171 and 172.

Similar to the exemplary embodiment shown in FIG. 4, the present embodiment shown in FIG. 8 can decrease the number of data driving chips and thus reduce manufacturing costs. In addition, according to the present embodiment, it is possible to form red, green, and blue pixels in the same structure in the entire display area and thus to ensure the uniformity of display.

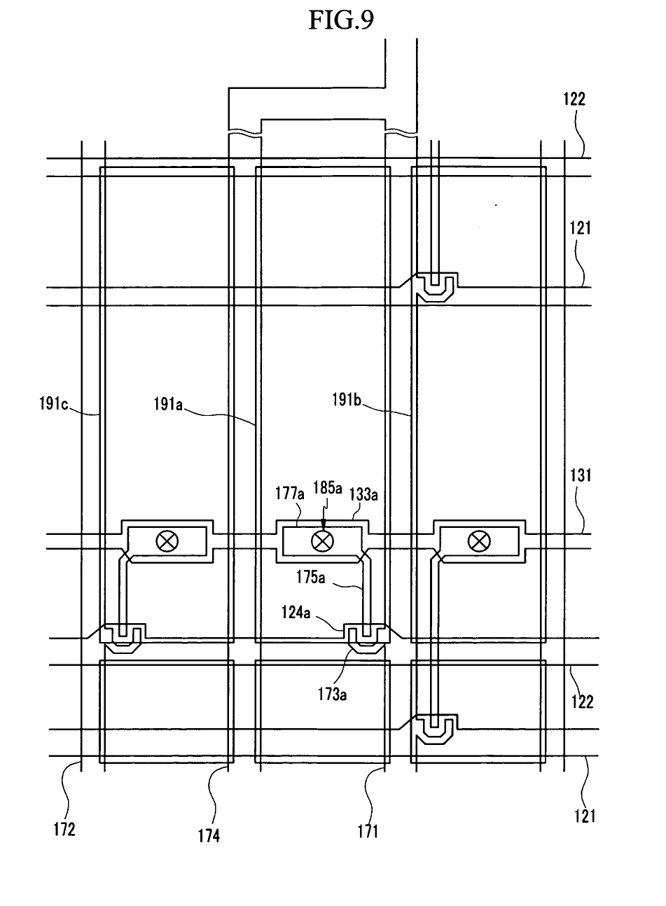

FIG. 9 is a layout view illustrating the thin film transistor array panel according to still another exemplary embodiment of the present invention. The difference between the thin film transistor array panel shown in FIG. 9 and the thin film transistor array panel shown in FIG. 4 will be described below.

A storage electrode line 131 is formed in the same layer where gate lines 121 and 122 are formed so as to be separated from gate lines 121 and 122. Storage electrode line 131 has a plurality of storage electrodes 133a protruding upward and downward.

Data line 172 for supplying image signals to the first pixel column, that is, the right pixel column among three pixel columns belonging to one pixel column group, is disposed on the left side of the first pixel column, and the data line 171 for supplying image signals to the second pixel column and the third pixel column is disposed between the second pixel column and the third pixel column. In addition to data lines 171 and 172, a redundant data line 174 that is not connected to the thin film transistor is formed between the first pixel column and the second pixel column. The redundant data line 174 is connected to the data line 171 outside display area. Drain electrode 175a includes an expanded portion 177a having a large width, and the expanded portion 177a is disposed so as to overlap storage electrode 133a. The expanded portion is provided to increase the capacitance of storage capacitor.

A passivation layer (not shown) made of an organic insulating material is formed with a predetermined thickness on data lines 171, 172, and 174 and drain electrode 175a. Pixel electrodes 191a, 191b, and 191c are formed on passivation layer with a large width so as to overlap data lines 171, 172, and 174 and gate line 122. Passivation layer formed of the organic insulating material with a large thickness enables a reduction in coupling between data lines 171, 172, and 174 and pixel electrodes 191a, 191b, and 191c. Therefore, pixel electrodes 191a, 191b, and 191c can be formed so as to partially cover data lines 171, 172, and 174, which makes it possible to ensure a high aperture ratio.

The redundant data line 174 can prevent the leakage of light from a boundary between two adjacent pixel columns.

In the third pixel column, since gate line 121 overlaps pixel electrodes in the next row, it is possible to prevent an increase in parasitic capacitance that causes flicker due to the overlap between pixel electrodes and gate lines in the current row.

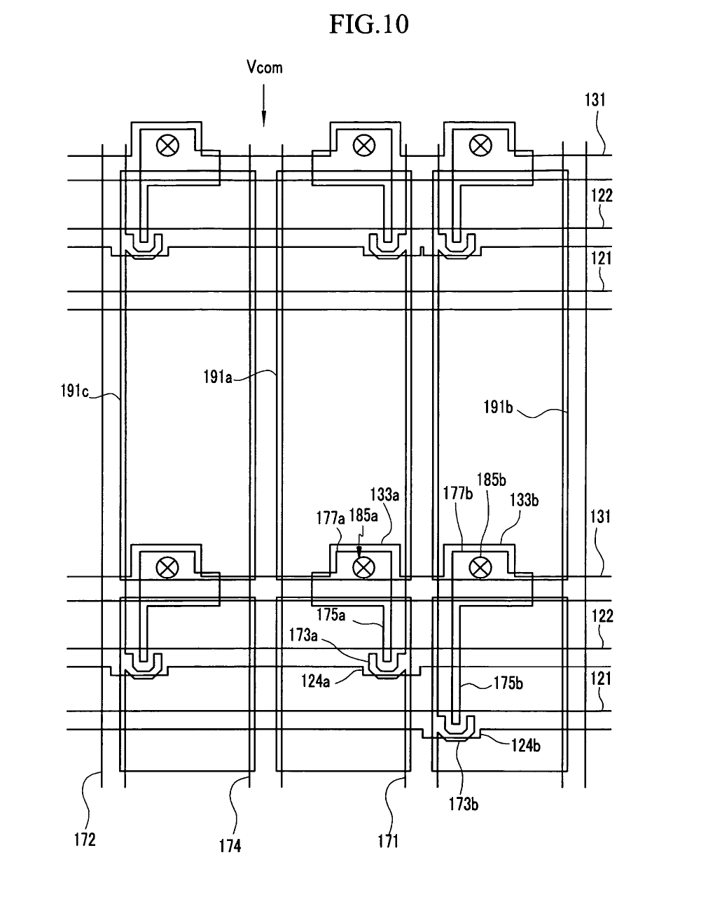

FIG. 10 is a layout view illustrating a thin film transistor array panel according to still another exemplary embodiment of the present invention.

As compared with the exemplary embodiment shown in FIG. 9, the present exemplary embodiment shown in FIG. 10 is characterized in that common electrode voltage Vcom is applied to the redundant data line 174. Since two gate lines 121 and 122 are disposed below pixel electrodes 191a, 191b, and 191c in the next row, it is possible to prevent an increase in parasitic capacitance that causes flicker due to the overlap between pixel electrodes 191a, 191b, and 191c and gate lines 121 and 122 in the current row.

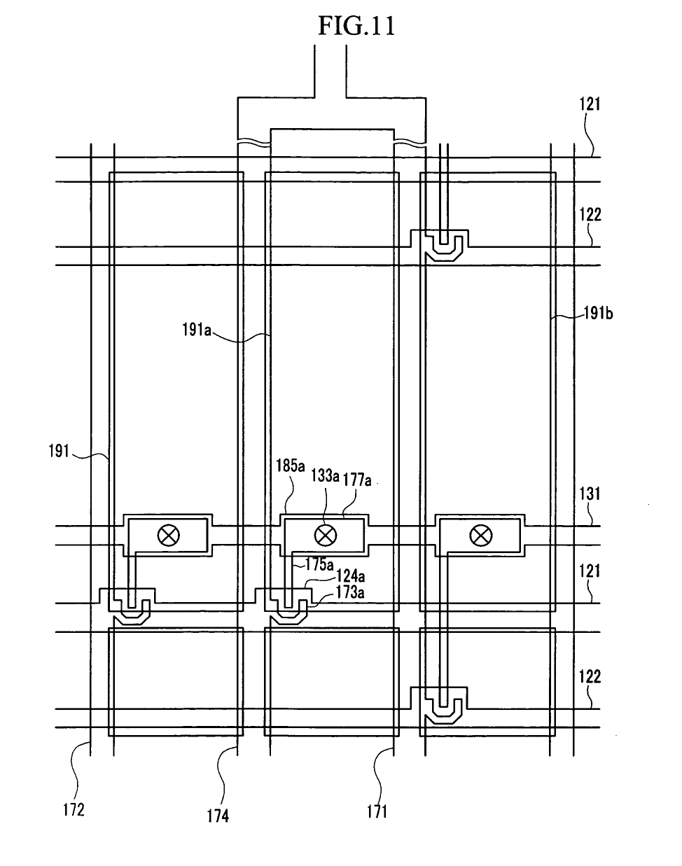

FIG. 11 is a layout view illustrating a thin film transistor array panel according to yet another exemplary embodiment of the present invention.

As compared with the exemplary embodiment shown in FIG. 9, the exemplary embodiment shown in FIG. 11 is characterized in that a thin film transistor is formed so as to be connected to a redundant data line 174, instead of forming the thin film transistor on the left side of the data line 171, and the redundant data line 174 is connected to a pixel electrode 191a disposed on the right side of the redundant data line 174 through the thin film transistor. However, since the redundant data line 174 is connected to the data line 171 outside display area, the present exemplary embodiment shown in FIG. 11 uses the same driving method as the exemplary embodiment shown in FIG. 9. That is, image signals to be supplied to the first pixel column and the second pixel column are applied to data lines 171, 172, and 174 at the time when an on signal is supplied to gate line 122, and image signals to be supplied to the third pixel column are applied to data lines 171 and 174 at the time when the on signal is supplied to gate line 121. The thin film transistor array panel according to the exemplary embodiment shown in FIG. 11 may perform the overlap driving described in FIG. 7A or FIG. 7B.

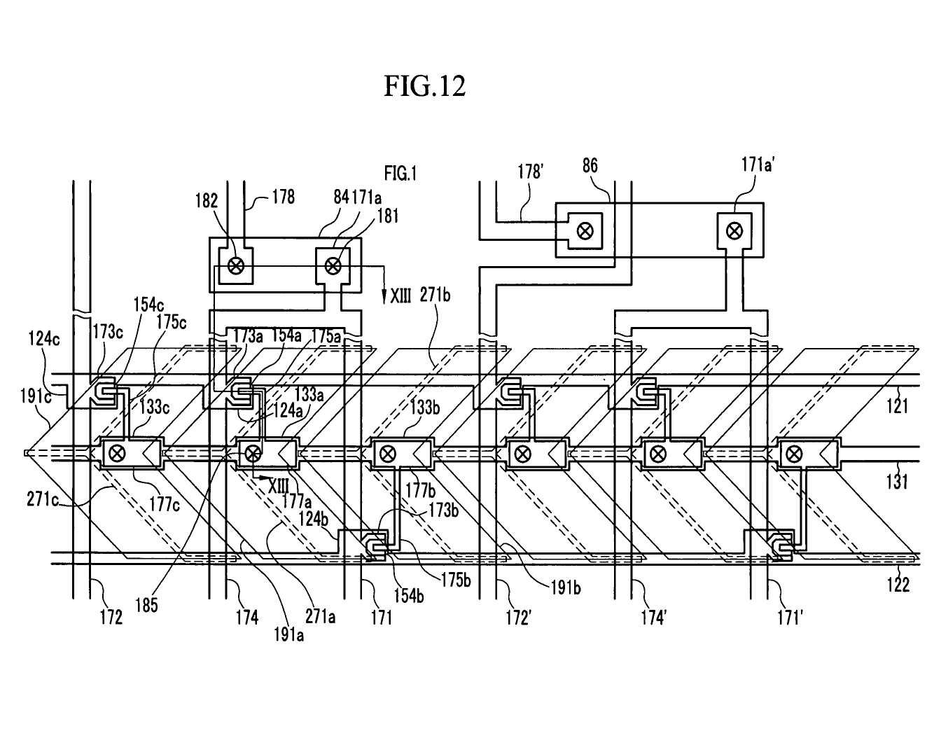

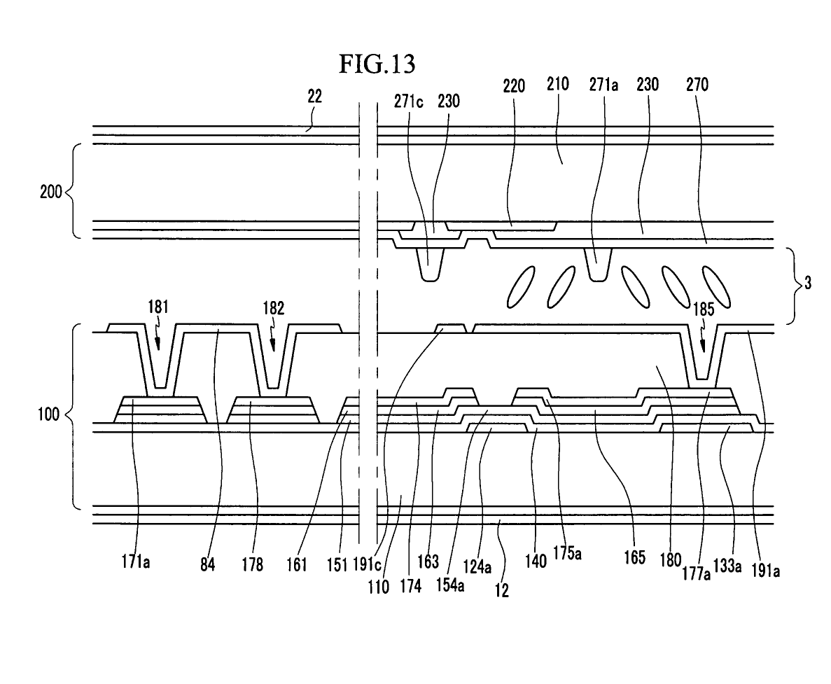

FIG. 12 is a layout view of a liquid crystal display according to still yet another exemplary embodiment of the present invention, and FIG. 13 is a cross-sectional view taken along the line XIII-XIII of FIG. 12.

Liquid crystal display shown in FIGS. 12 and 13 is an example of a vertical-alignment-type liquid crystal display in which the major axes of liquid crystal molecules are aligned vertical to the surfaces of display panels 100 and 200, and dielectric protrusions or cutout portions are used as alignment control means for controlling the alignment of liquid crystal molecules when an electric field is applied.

Referring to FIGS. 12 and 13, a liquid crystal panel assembly according to the exemplary embodiment of the present invention includes a thin film transistor array panel 100, a common electrode panel 200, and a liquid crystal layer 3 interposed between display panels 100 and 200.

First, the thin film transistor array panel 100 will be described in detail. A plurality of pairs of gate lines 121 and 122 and a plurality of storage electrode lines 131 are formed on an insulation substrate 110 formed of, for example, transparent glass.

Gate lines 121 and 122 transmit gate signals, and extend substantially in the horizontal direction. A pair of gate lines 121 and 122 are formed above and below pixels, respectively. Each gate line 121 includes a plurality of gate electrodes 124a and 124c protruding downward, and each gate line 122 includes a plurality of gate electrodes 124c protruding upward.

Storage electrode lines 131 are supplied with a predetermined voltage, and extend substantially in parallel to gate lines 121 and 122 so as to be adjacent to each other. Each storage electrode line 131 includes storage electrodes 133a, 133b, and 133c protruding upward and downward. The shape and arrangement of storage electrode lines 131 may vary.

Gate lines 121 and 122 and storage electrode line 131 may be formed of an aluminum-based metallic material such as aluminum (Al) or an aluminum alloy, a silver-based metallic material such as silver (Ag) or a silver alloy, a copper-based metallic material such as copper (Cu) or a copper alloy, a molybdenum-based metallic material such as molybdenum (Mo) or a molybdenum alloy, chromium (Cr), tantalum (Ta), or titanium (Ti). Alternatively, gate lines 121 and 122 and storage electrode line 131 may include a multilayered structure of two conductive layers (not shown) having different physical properties. One of the two conductive layers may be formed of a metallic material having low resistivity, for example an aluminum-based metallic material, a silver-based metallic material, or a copper-based metallic material, in order to reduce a signal delay or voltage drop. In contrast, the other layer may be formed of a different material from that forming the one layer, that is, a material having good chemical, physical, and electrical contact characteristics with, particularly, ITO (indium tin oxide) and IZO (indium zinc oxide), such as a molybdenum-based metallic material, chromium, tantalum, or titanium. For example, a chromium layer and an aluminum (alloy) layer may be used as the lower layer and upper layer, respectively, or an aluminum (alloy) layer and molybdenum (alloy) layer may be used as the lower layer and upper layer, respectively. However, gate line 121 and 122 and storage electrode line 131 may be formed of conductors or metallic materials other than the above-mentioned metallic materials. The side surfaces of gate lines 121 and 122 storage electrode line 131 are inclined with respect to the surface of the substrate 110, preferably at an angle of about 30° to 80°.

A gate insulating layer 140 formed of, for example, silicon nitride (SiNx) or silicon oxide (SiOx) is formed on gate lines 121 and 122 and storage electrode line 131.

A plurality of semiconductor stripes 151 formed of, for example, hydrogenated amorphous silicon (amorphous silicon is abbreviated to a-Si) or polysilicon are formed on gate insulating layer 140. Semiconductor stripes 151 include protruding portions 154a, 154b, and 154c respectively positioned above gate electrodes 124a, 124b, and 124c.

A plurality of ohmic contact stripes 161 and an ohmic contact island 165 are formed above each semiconductor stripe 151. Ohmic contact stripe 161 has a protruding portion 163 opposite ohmic contact island 165 above the protruding portions 154a, 154b, or 154c of semiconductor stripe 151. Ohmic contact stripe 161 may be formed of, for example, a material such as n+ hydrogenated amorphous silicon heavily doped with an n-type impurity, or silicide.

The side surfaces of each semiconductor stripe 151 and ohmic contacts 161 and 165 are inclined with respect to the surface of the substrate 110 at an angle of about 30° to 80°.

A data conductor including a plurality of data lines 171, 172, 174, 171′, 172′, and 174′ and a plurality of drain electrodes 175a, 175b, and 175c is formed on ohmic contacts 161 and 165 and gate insulating layer 140.

Data lines 171, 172, 174, 171′, 172′, and 174′ transmit data signals, and extend substantially in the vertical direction so as to intersect gate lines 121 and 122 and storage electrode line 131. Data lines 171, 172, and 174 include source electrodes 173a, 173b, and 173c that extend toward gate electrodes 124a, 124b, and 124c and have U shapes with opened portions facing the right side, respectively. Data lines 171 and 174 are connected to each other by a connecting portion 171a, and data lines 171′ and 174′ are connected to each other by a connecting portion 171a′. The ends of the connecting portions 171a and 171a′ are expanded.

Drain electrodes 175a, 175b, and 175c are separated from data lines 171, 172, 174, 171′, 172′, and 174′ so as to be respectively opposite the source electrode 173a, 173b, and 173c with gate electrodes 124a, 124b, and 124c as the centers. The two drain electrodes 175a and 175c respectively extend from the source electrodes 173a and 173c surrounding the two drain electrodes 175a and 175c toward gate line 121 and are bent in the downward direction at an angle of 90°. Drain electrode 175b extends from the source electrode 173b surrounding drain electrode 175b toward gate line 121 and is bent in the upward direction at an angle of 90°. Drain electrodes 175a, 175b, and 175c have expanded portions 177a, 177b, and 177c at positions overlapping storage electrodes 133a, 133b, and 133c, respectively. The expanded portions 177a, 177b, and 177c function to increase the capacitance of storage capacitors. Driving signal lead lines 178 and 178′ are formed on gate insulating layer 140 outside display area.

Assuming that one pixel column group is composed of three pixel columns, lead portions of data lines 171, 172, and 174 for driving odd-numbered pixel column groups have different arrangement structures from those of data lines 171′, 172′, and 174′ for driving even-numbered pixel column groups. That is, the data line 172 is formed in a straight line at a position departing from a space between the lead line 178 and the connecting portion 171a. However, the data line 172′ is bent twice at a right angle so as to pass between the lead line 178′ and the connecting portion 171a′.

The reason why data lines 171, 172, 174, 171′, 172′, and 174′ are formed in different arrangement structures in the odd-numbered pixel column groups and the even-numbered pixel column groups is to perform uniform dot inversion driving when the data driving chip is used to drive liquid crystal display according to the exemplary embodiment of the present invention.

Data lines 171, 172, 174, 171′, 172′, and 174′, drain electrodes 175a, 175b, and 175c, and the driving signal lead lines 178 and 178′ have substantially the same plane pattern as that of ohmic contacts 161 and 165, and also have substantially the same plane pattern as semiconductor 151, except between the source electrodes 173a, 173b, and 173c and drain electrodes 175a, 175b, and 175c.

A gate electrode 124a, 124b, or 124c, a source electrode 173a, 173b, or 173c, and a drain electrode 175a, 175b, or 175c form a thin film transistor (TFT) together with a semiconductor 154a, 154b, or 154c. The channel of the thin film transistor is formed in semiconductor 154a, 154b, or 154c between the source electrode 173a, 173b, or 173c and drain electrode 175a, 175b, or 175c.

Data conductors 171, 172, 174, 171′, 172′, 174′, 175a, 175b, and 175c may be formed of a refractory metallic material, such as molybdenum, chromium, tantalum, titanium, or an alloy thereof, or they may have a multilayered structure of a refractory metal layer (not shown) and a conductive layer (not shown) having low resistance. Examples of the multilayered structure include a two-layer structure of a chromium or molybdenum (alloy) layer serving as a lower layer, and an aluminum (alloy) layer serving as an upper layer, and a three-layer structure of a molybdenum (alloy) layer serving as a lower layer, an aluminum (alloy) layer serving as an intermediate layer, and a molybdenum (alloy) layer serving as an upper layer. However, the data conductors 171, 175a, 175b may be formed of various conductors or metallic materials other than the above-mentioned metallic materials.

The side surfaces of the data conductors 171, 172, 174, 171′, 172′, 174′, 175a, 175b, and 175c are preferably inclined with respect to the surface of the substrate 110 at an angle of 30° to 80°.

Ohmic contacts 161 and 165 are provided only between semiconductors 151, 154a, 154b, and 154c and the data conductors 171, 172, 174, 171′, 172′, 174′, 175a, 175b, and 175c to reduce contact resistance therebetween. Semiconductors 151, 154a, 154b, and 154c are exposed between the source electrodes 173a, 173b, and 173c and drain electrodes 175a, 175b, and 175c, respectively, and also have exposed portions not covered with the data conductors 171, 172, 174, 171′, 172′, 174′, 175a, 175b, and 175c.

A passivation layer 180 is formed on data conductors 171, 172, 174, 171′, 172′, 174′, 175a, 175b, and 175c and the exposed portions of semiconductors 154a, 154b, and 154c. Passivation layer 180 has a small dielectric constant, and is formed of an organic insulator having a large thickness. In this way, even when pixel electrodes 191a, 191b, and 191c overlap data lines 171, 172, and 174, respectively, distances between pixel electrodes 191a, 191b, and 191c and data lines 171, 172, and 174 increase, and the dielectric constant of the dielectric material decreases, which results in small capacitance. The organic insulator preferably has a dielectric constant smaller than 4.0, and it may have photosensitivity. Passivation layer 180 may be formed of a non-organic insulator. In addition, passivation layer 180 may have a dual-layer structure of a lower inorganic layer and an upper organic layer to improve insulating characteristics of the organic layer and to prevent the exposed semiconductors 154a, 154b, and 154c from being damaged.

A plurality of contact holes 181 for exposing the data line connecting potions 171a and 171a′, a plurality of contact holes 185 for exposing the expanded portions 177a, 177b, and 177c of drain electrodes 175a, 175b, and 175c, and a plurality of contact holes 182 for exposing the ends of the lead portions 178 and 178′ are formed in passivation layer 180. A plurality of contact holes (not shown) for exposing the ends of gate lines 121 are formed in passivation layer 180 and gate insulating layer 140.

A plurality of pixel electrodes 191a, 191b, and 191c and a plurality of connecting members 84 and 86 are formed on passivation layer 180. Pixel electrodes and the connecting members may be formed of a transparent conductive material such as ITO or IZO, or a reflective metallic material such as aluminum, silver, chromium, or an alloy thereof.

Pixel electrodes 191a, 191b, and 191c each include two parallelogram-shaped electrode pieces inclined in different directions. Oblique sides of the two electrode pieces intersect each other to form a pair of curved edges.

Pixel electrodes 191a, 191b, and 191c are connected to drain electrodes 175a, 175b, and 175c through the contact holes 185, respectively.

A pixel electrode 191a, 191b, or 191c, a common electrode 270 of the upper panel 200, and a liquid crystal layer 3 interposed therebetween form a liquid crystal capacitor C_{LC}. Liquid crystal capacitor C_{LC} holds the applied voltage after the thin film transistor is turned off.

Pixel electrodes 191a, 191b, and 191c and drain electrodes 175a, 175b, and 175c connected to pixel electrodes 191a, 191b, and 191c overlap storage electrodes 133a, 133b, and 133c, respectively, to form storage capacitors C_{ST}. Storage capacitors C_{ST} improve the voltage holding performance of liquid crystal capacitor C_{LC}.

A connecting member 84 comes into contact with the connecting portion 171a and the lead line 178 through the contact holes 181 and 182 to connect the connecting portion 171a and the lead line 178. A connecting member 86 comes into contact with the connecting portion 171a′ and the lead line 178′ through the contact holes 181 and 182 and connects the connecting portion 171a′ and the lead line 178′ across the data line 172′. The connecting portion 171a and the lead line 178 of the odd-numbered pixel column group can be directly connected to each other. However, the connecting portion 171a and the lead line 178 of the odd-numbered pixel column group are connected to each other through the connecting member 84 in order to matching a wiring load with the even-numbered pixel column group.

Next, the upper panel 200 will be described. A light blocking member 220 is formed on an insulation substrate 210 formed of transparent glass or plastic, for example. The light blocking member 220 may includes curved portions (not shown) corresponding to the curved edges of pixel electrodes 191a, 191b, and 191c and quadrangle portions (not shown) corresponding to the thin film transistors. The light blocking member 220 prevents light from leaking among pixel electrodes 191a, 191b, and 191c and defines opening regions opposite to pixel electrodes 191a, 191b, and 191c.

A plurality of color filters 230 are formed on the substrate 210 and the light blocking member 220. The color filters 230 are provided in a region surrounded by the light blocking member 220, and may extend along columns of pixel electrodes 191a, 191b, and 191c. Each of the color filters 230 can display one of the three primary colors of red, green, and blue.

Common electrode 270 is formed on the color filters 230 and the light blocking member 220. Common electrode 270 is formed of a transparent conductive material, such as ITO or IZO.

Protrusions 271a, 271b, and 271c are formed on common electrode 270. The protrusions 271a, 271b, and 271c may be formed of an organic material or an inorganic material. The number of protrusions 271a, 271b, and 271c depends on design factors. The light blocking member 220 overlaps the protrusions 271a, 271b, and 271c, which makes it possible to prevent light from leaking from the protrusions 271a, 271b, and 271c. Each of the protrusions 271a, 271b, and 271c is arranged at a position dividing pixel electrode 191a, 191b, or 191c into two parts in the horizontal direction in a plan view, and includes a curved portion overlapping the upper and lower sides of pixel electrode 191a, 191b, or 191c in a plan view and a central portion laterally extending at the center in the vertical direction.

Alignment layers (not shown) are formed on the inner surfaces of display panels 100 and 200, respectively. The alignment layers 11 and 21 may be vertical alignment layers.

Polarizers (12, 22) are provided on the outer surfaces of display panels 100 and 200. The polarizing axes of the two polarizers are orthogonal to each other. It is preferable that the polarizing axes be inclined at an angle of about 45° with respect to the curved sides of pixel electrodes 191a, 191b, and 191c. In a reflective liquid crystal display, one of the two polarizers may be omitted.

Liquid crystal display may include a backlight unit (not shown) for supplying light to the polarizers 12 and 22, the retardation layers, display panels 100 and 200, and liquid crystal layer 3.

Liquid crystal layer 3 has negative dielectric anisotropy. When no electric field is applied, liquid crystal molecules of liquid crystal layer 3 are aligned such that the major axes thereof are vertical with respect to the surfaces of the two display panels.

The protrusions 271a, 271b, and 271c may be replaced with cutout portions (not shown) formed in common electrode 270 or depressed portions (not shown). The protrusions 271a, 271b, and 271c may be disposed below field generating electrodes 191 and 270. The protrusions 271a, 271b, and 271c change an electric field generated between common electrode 270 and pixel electrodes 191a, 191b, and 191c to control the alignment of liquid crystal.

In the thin film transistor array panel having the above-mentioned structure, since the two data lines 171 and 174 are connected to each other, the number of data driving chips for supplying signals to data lines is smaller than that in the conventional thin film transistor array panel, which makes it possible to reduce manufacturing costs. In contrast, the number of gate lines doubles, which causes the number of gate driving chips to double. However, since gate driving chips are inexpensive, it does not have a significant effect on the manufacturing costs. Further, since a gate driving circuit for supplying driving signals to gate lines 121 performs a very simple function, gate driving circuit can be integrated into the substrate 110 by using a thin film transistor forming process, which makes it possible to prevent an increase in the number of gate driving chips.

In the thin film transistor array panel having the above-mentioned structure, when three pixel columns belonging to one pixel column group are arranged so as to correspond to red, green, and blue pixel columns, the red, green, and blue pixels have the same shape in the entire display area. Therefore, it is possible to ensure the uniformity of display and thus to improve display quality.

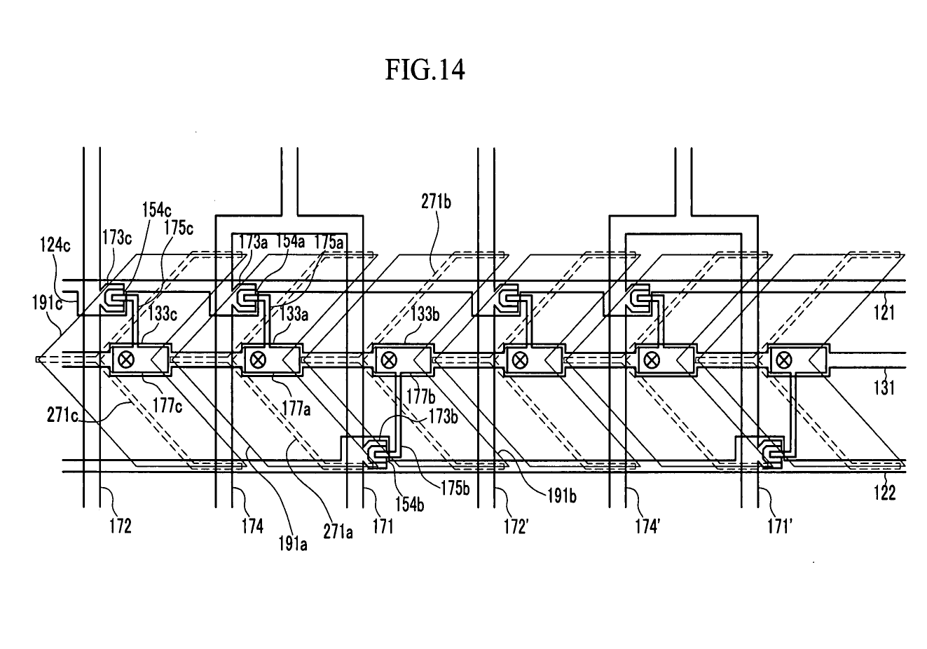

FIG. 14 is a layout view illustrating a liquid crystal display according to still another exemplary embodiment of the present invention. As compared with the exemplary embodiment shown in FIG. 13, the exemplary embodiment shown in FIG. 14 is characterized in that data lines 172 and 172′ do not intersect pairs of data lines 171, 174, 171′, and 174′, regardless of odd-numbered pixel array groups and even-numbered pixel array groups.

When liquid crystal display having the above-mentioned structure is driven by a data driving chip for two-dot inversion driving, three-dot inversion driving is performed, as shown in FIG. 3.

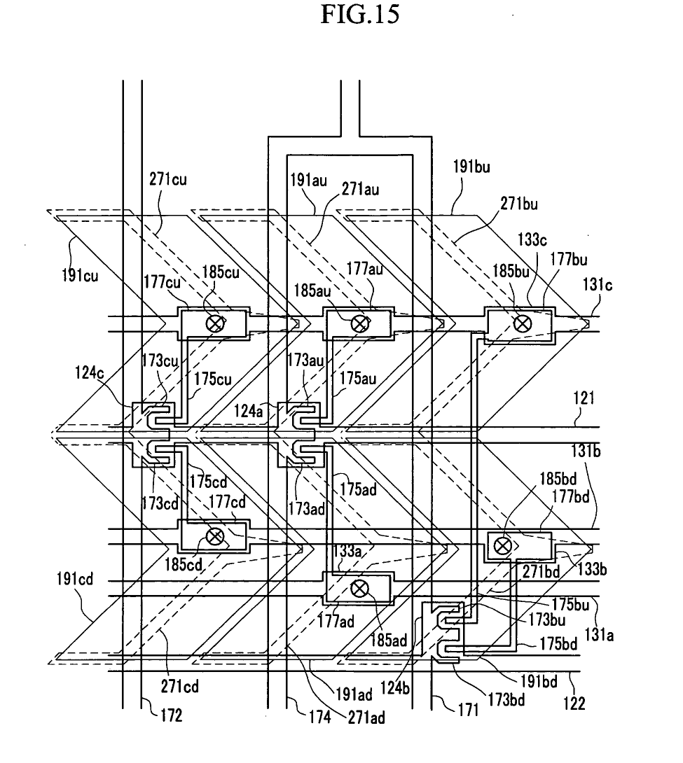

FIG. 15 is a layout view illustrating a liquid crystal display according to still another embodiment of the present invention. The layer structure of liquid crystal display according to the exemplary embodiment shown in FIG. 15 is substantially similar to those of liquid crystal displays according to the exemplary embodiments shown in FIGS. 12 and 13, and thus a full description thereof will be omitted. Therefore, only the arrangement structure of the layers of liquid crystal display will be described below.

A plurality of pairs of gate lines 121 and 122 extend in the horizontal direction. A plurality of groups of storage electrode lines 131a, 131b, and 131c are formed in parallel to gate lines 121 and 122. Gate line 121 has a plurality of gate electrodes 124a and 124b, and gate line 122 has a plurality of gate electrodes 124c. Storage electrode lines 131a, 131b, and 131c have storage electrodes 133a, 133b, and 133c, respectively.

A plurality of data lines 171, 172, and 174 intersect gate lines 121 and 122 and storage electrode lines 131a, 131b, and 131c so as to not be electrically connected thereto. The data line 171 has a plurality of pairs of source electrodes 173bd and 173bu, the data line 172 has a plurality of pairs of source electrodes 173cd and 173cu, and the data line 174 has a plurality of pairs of source electrodes 173ad and 173au. The two data lines 171 and 174 are connected to each other outside display area.

A plurality of pairs of drain electrodes 175ad and 175au are opposite to each other on the source electrodes 173ad and 173au and gate electrode 124a. Drain electrodes 175ad and 175au extend in the downward and upward directions, respectively, and have expanded portions 177ad and 177au overlapping storage electrodes 133a and 133c at the ends thereof, respectively. A plurality of pairs of drain electrodes 175bd and 175bu are opposite to each other on the source electrodes 173bd and 173bu and gate electrode 124b. Drain electrodes 175bd and 175bu extend in the upward and downward directions, respectively, and have expanded portions 177bd and 177bu overlapping storage electrodes 133b and 133c at the ends thereof, respectively. A plurality of pairs of drain electrodes 175cd and 175cu are opposite to each other on the source electrodes 173cd and 173cu and gate electrode 124c. Drain electrodes 175cd and 175cu extend in the downward and upward directions, respectively, and have expanded portions 177bd and 177bu overlapping storage electrodes 133b and 133c at the ends thereof, respectively.

The structure of contact assistants (not shown) and semiconductor (not shown) forming the thin film transistor is the same as those in the above-mentioned exemplary embodiments, and thus a description thereof will be omitted.

A plurality of pairs of sub-pixel electrodes 191cu and 191cd are formed in the first pixel column of three pixel columns belonging to one pixel column group. A plurality of pairs of sub-pixel electrodes 191au and 191ad are formed in the second pixel column. A plurality of pairs of sub-pixel electrodes 191bu and 191bd are formed in the third pixel column.

The sub-pixel electrodes 191au, 191ad, 191bu, 191bd, 191cu, and 191cd each include two parallelogram-shaped electrode pieces inclined in different directions. Oblique sides of the two electrode pieces intersect each other to form a pair of curved edges. The sub-pixel electrodes 191au and 191ad, 191bu and 191bd, or 191cu and 191cd have inversion symmetry with respect to gate line 121.

The sub-pixel electrodes 191au and 191ad are connected to expanded portions 177au and 177ad of drain electrode through contact holes 185au and 185ad, respectively. The sub-pixel electrodes 191bu and 191bd are connected to expanded portions 177bu and 177bd of drain electrode through contact holes 185bu and 185bd, respectively. The sub-pixel electrodes 191cu and 191cd are connected to expanded portions 177cu and 177cd of drain electrode through contact holes 185cu and 185cd, respectively.

Protrusions 271au, 271ad, 271bu, 271bd, 271cu, and 271cd of the upper panel are arranged at positions dividing each of the sub-pixel electrodes 191au, 191ad, 191bu, 191bd, 191cu, and 191cd in the horizontal direction. Each of the protrusions includes a curved portion overlapping the upper and lower sides of a sub-pixel electrode 191au, 191ad, 191bu, 191bd, 191cu, or 191cd in a plan view and a central portion laterally extending at the center in the vertical direction.

In liquid crystal display, when a voltage is applied to gate line 121, image signal voltages are charged to the sub-pixel electrodes 191cu, 191cd, 191au, and 191ad in the first pixel column and the second pixel column. Then, when an off-voltage is applied to gate line 121 and an on-voltage is applied to gate line 122, image signal voltages are charged to the sub-pixel electrodes 191bu and 191bd in the third pixel column. Each pair of sub-pixel electrodes 191au and 191ad, 191bu and 191bd, and 191cu and 191cd forms one pixel electrode. Therefore, in order to charge one pixel row with an image signal voltage, gate-on voltage must be applied to a pair of gate lines 121 and 122.

While the image signal voltage is being charged to all the sub-pixel electrodes 191au, 191ad, 191bu, 191bd, 191cu, and 191cd in one pixel row, all of storage electrode lines 131a, 131b, and 131c are kept in a floating state. Subsequently, when gate-on voltage is applied to the next gate line 121 in order to charge the sub-pixel electrodes 191au, 191ad, 191bu, 191bd, 191cu, and 191cd in the next pixel row with the image signal voltage, a predetermined voltage is applied to storage electrode lines 131a, 131b, and 131c in the previous pixel row that are in the floating state. In this case, the same voltage is applied to the two storage electrode lines 131a and 131b, but a different voltage is applied to storage electrode line 131c. Different voltages may be applied to storage electrode lines 131a and 131b, if necessary.

When voltages are applied to storage electrode lines 131a, 131b, and 131c in the floating state, the voltages of pixel electrodes 191au, 191ad, 191bu, 191bd, 191cu, and 191cd that are in the floating state vary. At that time, different voltages are applied to storage electrode lines 131a and 131b and storage electrode line 131c, which causes the voltage of the upper sub-pixel electrodes 191au, 191bu, and 191cu to differ from the voltage of the lower sub-pixel electrodes 191ad, 191bd, and 191cd. Then, two regions having different voltages are formed in one pixel, which results in a reduction in the distortion of a gamma curve in the side surface.

In the thin film transistor array panel having the above-mentioned structure, since the two data lines 171 and 174 are connected to each other, the number of data driving chips for supplying signals to data lines is smaller than that in the conventional thin film transistor array panel, which makes it possible to reduce manufacturing costs. In contrast, the number of gate lines doubles, which causes the number of gate driving chips to double. However, since gate driving chip is inexpensive, it does not have a significant effect on the manufacturing costs. Further, since a gate driving circuit for supplying driving signals to gate lines 121 performs a very simple function, gate driving circuit can be integrated into the substrate 110 by using a thin film transistor forming process, which makes it possible to prevent an increase in the number of gate driving chips.

In the thin film transistor array panel having the above-mentioned structure, when three pixel columns belonging to one pixel column group are arranged so as to correspond to red, green, and blue pixel columns, red, green, and blue pixels have the same shape in the entire display area. Therefore, it is possible to ensure the uniformity of display and thus to improve display quality.

According to the exemplary embodiments of the present invention, it is possible to decrease the number of data driving chips for supplying signals to data lines, as compared with the conventional thin film transistor array panel, and thus to reduce manufacturing costs. In the thin film transistor array panel having the above-mentioned structure, when three pixel columns belonging to one pixel column group are arranged so as to correspond to red, green, and blue pixel columns, red, green, and blue pixels have the same shape in the entire display area. Therefore, it is possible to ensure the uniformity of display and thus to improve display quality.

While this invention has been described in connection with what is presently considered to be practical exemplary embodiments, it is to be understood that various modifications and equivalent arrangements will be apparent to those skilled in the art and may be made without, however, departing from the spirit and scope of the invention.

What is claimed is:

1. A thin film transistor array panel comprising:
a plurality of pixels including pixel electrodes arranged in a matrix of rows and columns having switching elements connected to the pixel electrodes;
first and second gate lines extending in a row direction connected to the switching elements; and
first and second data lines extending in a column direction for serving three pixel columns of the matrix, the switching elements connecting pixel electrodes in the first and second pixel columns to the first data line and connecting pixel electrodes in the third pixel column to the second data line.

2. The thin film transistor array panel of claim 1, wherein the pixel electrodes in the first and third pixel columns are connected to the first gate line through respective ones of the switching elements, and the pixel electrodes in the second pixel column are connected to the second gate line through other respective ones of the switching elements.

3. The thin film transistor array panel of claim 2, further comprising
a gate driving circuit that supplies a gate-on voltage or a gate-off voltage to the first and second gate lines, the gate-on voltage being applied to the first gate line for a predetermined time while a gate-on voltage is applied to the second gate line.

4. The thin film transistor array panel of claim 3, further comprising a data driving circuit that supplies image signals to the first and second data lines, wherein the data driving circuit supplies two-dot inversion driving signals.

5. The thin film transistor array panel of claim 1, further comprising redundant data lines corresponding to the first to third pixel columns.

6. The thin film transistor array panel of claim 5, wherein the redundant data lines are connected to the first data lines.

7. The thin film transistor array panel of claim 5, wherein a predetermined voltage is applied to the redundant data lines.

8. A thin film transistor array panel comprising:
a plurality of pixels including pixel electrodes arranged in a matrix and switching elements connected to the pixel electrodes;
first and second gate lines connected to the switching elements serving a row of pixel electrodes,
first to third data lines connected to the switching elements corresponding to three pixel columns, pixel electrodes in the first pixel column being connected to the first data line through certain of the switching elements, pixel electrodes in the second pixel columns being connected to the second data line through others of the switching elements, pixel electrodes in the third pixel column being connected to the third data line through still others of the switching elements, the first and second data lines being electrically connected to each other.

9. The thin film transistor array panel of claim 8,
wherein the pixel electrodes in the first and third pixel columns are connected to the first gate line through certain of the switching elements, and
the pixel electrodes in the second pixel columns are connected to the second gate line through others of switching elements.

10. The thin film transistor array panel of claim 9, further comprising
a gate driving circuit that supplies a gate-on voltage or a gate-off voltage to the first and second gate lines,
wherein, while applying the gate-on voltage to the first gate line, the gate driving circuit applies the gate-on voltage to the second gate line.

11. The thin film transistor array panel of claim 10, further comprising
a data driving circuit that supplies image signals to the first and second data lines,
wherein the data driving circuit supplies two-dot inversion driving signals.

12. The thin film transistor array panel of claim 8, further comprising:
connecting portions, each of which connects the first data line to the second data line;
lead portions that connect the first and second data lines to the data driving circuit; and
connecting members that connect the lead portions to the connecting portions,
wherein at least a part of the third data line passes between the lead portion and the connecting portion to be connected to the data driving circuit.

13. The thin film transistor array panel of claim 8,
wherein, when one pixel column group is composed of the first to third pixel columns that are sequentially arranged, the third data line of an even-numbered pixel column group passes between the lead portion and the connecting portion to be connected to the data driving circuit, and
the third data line of an odd-numbered pixel column group does not pass between the lead portion and the connecting portion.

14. The thin film transistor array panel of claim 8,
wherein each of the pixel electrodes includes two parallelogram-shaped electrode pieces inclined in different directions, and
oblique sides of the two electrode pieces intersect each other to form a pair of curved edges.

15. A thin film transistor array panel comprising:
a plurality of pairs of sub-pixel electrodes that are arranged in a matrix, a pair of sub-pixels serving as one pixel electrode;
a plurality of switching elements that are connected to the sub-pixel electrodes;
first and second gate lines that are connected to the switching elements, extend in a row direction, and correspond to one row of pixel electrodes;
first and the second storage electrode lines corresponding to one row of pixel electrodes; and
first to third data lines that are connected to the switching elements, extend in a column direction, and correspond to three pixel columns,
wherein, when the three pixel columns are referred to as first to third pixel columns, the sub-pixel electrodes in the first pixel column are connected to the first data line through certain of the switching elements,
the sub-pixel electrodes in the second pixel columns are connected to the second data line through others of the switching elements,
the sub-pixel electrodes in the third pixel column are connected to the third data line through still others of the switching elements, and
the first and second data lines are electrically connected to each other.

16. The thin film transistor array panel of claim 15,
wherein the sub-pixel electrodes in the first and third pixel columns are connected to the first gate line through certain of the switching elements, and
the sub-pixel electrodes in the second pixel columns are connected to the second gate line through others of the switching elements.

17. The thin film transistor array panel of claim 16,
wherein, when the pair of sub-pixel electrodes serving as one pixel electrode are referred to as first and second sub-pixel electrodes, the first sub-pixel electrode overlaps the first storage electrode line, and the second sub-pixel electrode overlaps the second storage electrode line.

18. The thin film transistor array panel of claim 17, further comprising third storage electrode lines that overlap the second sub-pixel electrodes.

19. The thin film transistor array panel of claim 19,
wherein different voltages are applied to the first storage electrode line and the second storage electrode line, and
the same voltage is applied to the second storage electrode line and the third storage electrode line.

20. The thin film transistor array panel of claim 20, wherein each of the switching elements includes:
a gate electrode that is connected to the first gate line or the second gate line;
a source electrode that is connected to any one of the first to third data lines; and
a drain electrode that is opposite to the source electrode above the gate electrode and has an expanded portion,
wherein the expanded portions of the drain electrodes in the first and third pixel columns overlap the first storage electrode lines, and
the expanded portions of the drain electrodes in the second pixel column overlap the second storage electrode lines.

21. The thin film transistor array panel of claim 15,
wherein each of the sub-pixel electrodes includes two parallelogram-shaped electrode pieces inclined in different directions, and
oblique sides of the two electrode pieces intersect each other to form a pair of curved edges.
